(19) United States
(12) Patent Application Publication
(10) Pub. No.: US 2019/0287169 A1
(43) Pub. Date: Sep. 19, 2019

(54) ACCOUNT MANAGEMENT USING REINFORCEMENT LEARNING

(71) Applicant: Capital One Services, LLC, McLean, VA (US)

(72) Inventor: Rashan Jibowu, Hoboken, NJ (US)

(73) Assignee: Capital One Services, LLC, McLean, VA (US)

(21) Appl. No.: 15/923,655

(22) Filed: Mar. 16, 2018

(51) Int. Cl. G06Q 40/02; G06N 99/00

(52) U.S. Cl. CPC G06Q 40/02; G06N 99/005

(57) ABSTRACT

A processor may receive first account state data for a first account associated with an account holder and second account state data for a second account associated with the account holder. The processor may automatically cause a transfer of value between the first account and the second account, the transfer causing a change in the first account's value and a change in the second account's value. The processor may detect a user-initiated transfer of value involving at least one of the first account and the second account. Using a reinforcement learning algorithm, the processor may evaluate the automatically-executed transfer of value and the user-initiated transfer of value to determine an effect of the automatically-executed transfer of value. The processor may store and/or modify a transfer policy in the at least one memory according to the effect of the automatically-executed transfer of value.

### BACKGROUND

People often have multiple financial accounts. For example, a bank customer may have a checking account and a savings account. The same customer may also have credit card accounts with the same bank and/or other accounts with other financial service providers. In some cases, such as the case of the checking and savings accounts with the same bank, the customer may be able to easily move money between the accounts. The customer may choose to do so in order to improve financial benefits associated with the accounts. For example, the customer might like to pay her bills from the checking account because there are few restrictions on withdrawals from this account. However, the customer might also like to keep a relatively high balance in the savings account because this account has a high interest rate. Accordingly, the customer may keep money in the savings account and move it to the checking account in advance of paying bills. Other customers having similar or different combinations of accounts may make their own decisions about how to take advantage of account benefits. Other customers may not make informed decisions to take advantage of account benefits at all, thereby missing opportunities.

### SUMMARY OF THE DISCLOSURE

Systems and methods described herein may use reinforcement learning techniques to monitor user behavior when interacting with a plurality of financial accounts. By monitoring the user behavior, an automated system may identify one or more changes that can be made to the accounts. The system may automatically make the changes and thereby optimize one or more financial benefits associated with the accounts. By using reinforcement learning, the system may perform the automatic account monitoring and optimization without requiring training on individual users, allowing the system to start working to optimize the benefits more quickly and store and/or maintain less data than systems that optimize accounts using other automatic and/or machine learning techniques. In some embodiments, the automated system may learn how to fully manage a user's accounts without user intervention.

For example, an account management method may include receiving, at a processor, first account state data for a first account associated with an account holder. The first account data may include a first value held in the first account. The method may include receiving, at the processor, second account state data for a second account associated with the account holder. The second account data may include a second value held in the second account. The method may include automatically executing, by the processor, a transfer of value between the first account and the second account. The transfer may cause a change in the first value and a change in the second value. The transfer may be executed in accordance with a transfer policy established by a reinforcement learning algorithm and stored in at least one memory. The method may include storing, by the processor, data describing the change in the first value in a first account data record in the at least one memory and storing, by the processor, data describing the change in the second value in a second account data record in the at least one memory. The method may include detecting, by the processor, a user-initiated transfer of value involving at least one of the first account and the second account. The method may include using the reinforcement learning algorithm to evaluate, by the processor, the automatically-executed transfer of value and the user-initiated transfer of value to determine an effect of the automatically-executed transfer of value. The method may include modifying, by the processor, the transfer policy in the at least one memory according to the effect of the automatically-executed transfer of value.

In some embodiments, the effect may include a positive outcome for at least one of the first value and the second value. Modifying the transfer policy may include indicating that the automatically-executed transfer of value is to be repeated.

In some embodiments, the effect may include a negative outcome for at least one of the first value and the second value. Modifying the transfer policy may include indicating that the automatically-executed transfer of value is to be changed. For example, indicating that the automatically-executed transfer of value is to be changed may include at least one of changing a timing for the automatically-executed transfer of value, changing a value of the automatically-executed transfer of value, and changing a direction of the automatically-executed transfer of value.

In some embodiments, the first account state data may indicate at least one action that can be performed to change the first value, and the second account state data may indicate at least one action that can be performed to change the second value. The method may further include identifying, by the processor, the transfer policy based on at least one of the first account state data and the second account state data.

In some embodiments, the method may further include receiving, at the processor, environmental data indicating at least one external factor affecting how the transfer of value is allowed to be executed. The method may further include identifying, by the processor, the transfer policy based on the environmental data.

In some embodiments, the method may further include identifying, by the processor, the transfer policy based on a previously-observed outcome, an experimental choice, or a combination thereof.

In another example, an account management policy creation method may include receiving, at a processor, first account state data for a first account associated with an account holder. The first account data may include a first value held in the first account. The method may include receiving, at the processor, second account state data for a second account associated with the account holder. The second account may include including a second value held in the second account. The method may include automatically determining, by the processor, a transfer of value for execution between the first account and the second account. The transfer may cause a change in the first value and a change in the second value. The method may include automatically executing, by the processor, the transfer of value between the first account and the second account. The method may include storing, by the processor, data describing the change in the first value in a first account data record in at least one memory, and storing, by the processor, data describing the change in the second value in a second account data record in at least one memory. The method may include detecting, by the processor, a user-initiated transfer of value involving at least one of the first account and the second account. The method may include using a reinforcement learning algorithm, evaluating, by the processor, the automatically-executed transfer of value and the user-initiated transfer of value to determine an effect of the automatically-executed transfer of value. The method may include storing, by the processor, a transfer policy in the at least one memory according to the effect of the automatically-executed transfer of value.

In some embodiments, the effect may include a positive outcome for at least one of the first value and the second value. Storing the transfer policy may include indicating that the automatically-executed transfer of value is to be repeated.

In some embodiments, the effect may include a negative outcome for at least one of the first value and the second value. Storing the transfer policy may include specifying a different automatically-executed transfer of value from the automatically-executed transfer of value that produced the negative outcome. For example, the different automatically-executed transfer of value may differ from the automatically-executed transfer of value that produced the negative outcome in at least one of a timing for the automatically-executed transfer of value, a value of the automatically-executed transfer of value, and a direction of the automatically-executed transfer of value.

In some embodiments, the first account state data may indicate at least one action that can be performed to change the first value. The second account state data may indicate at least one action that can be performed to change the second value. Automatically determining the transfer of value may be based on at least one of the first account state data and the second account state data.

In some embodiments, the method may further include receiving, at the processor, environmental data indicating at least one external factor affecting how the transfer of value is allowed to be executed. Automatically determining the transfer of value may be based on the environmental data.

In another example, a system may include at least one account server configured to store first account state data for a first account associated with an account holder, store second account state data for a second account associated with the account holder, and execute transfers of value causing changes in the first value and/or the second value. The first account data may include a first value held in the first account. The second account data may include a second value held in the second account. The system may include at least one account optimization apparatus including a processor and a non-transitory computer readable memory configured to store a transfer policy and instructions that, when executed by the processor, cause the processor to perform processing. The processing may include automatically directing the at least one account server to execute a transfer of value between the first account and the second account. The transfer may cause a change in the first value and a change in the second value. The at least one account server may store data describing the change in the first value and data describing the change in the second value. The processing may include detecting a user-initiated transfer of value involving at least one of the first account and the second account. The processing may include using a reinforcement learning algorithm to evaluate the automatically-executed transfer of value and the user-initiated transfer of value to determine an effect of the automatically-executed transfer of value. The processing may include storing or modifying the transfer policy in the memory according to the effect of the automatically-executed transfer of value.

In some embodiments, the effect may include a positive outcome for at least one of the first value and the second value. Storing or modifying the transfer policy may include indicating that the automatically-executed transfer of value is to be repeated.

In some embodiments, the effect may include a negative outcome for at least one of the first value and the second value. Storing the transfer policy may include specifying a different automatically-executed transfer of value from the automatically-executed transfer of value that produced the negative outcome. Modifying the transfer policy may include indicating that the automatically-executed transfer of value is to be changed. For example, indicating that the automatically-executed transfer of value is to be changed may include at least one of changing a timing for the automatically-executed transfer of value, changing a value of the automatically-executed transfer of value, and changing a direction of the automatically-executed transfer of value.

In some embodiments, the first account state data may indicate at least one action that can be performed to change the first value. The second account state data may indicate at least one action that can be performed to change the second value. The transfer policy may be based on at least one of the first account state data and the second account state data.

In some embodiments, the processing may further include receiving environmental data indicating at least one external factor affecting how the transfer of value is allowed to be executed. The processing may further include identifying a transfer policy specifying the transfer of value based on the environmental data.

In some embodiments, the processing may further include identifying a transfer policy specifying the transfer of value based on a previously-observed outcome, an experimental choice, or a combination thereof.

### BRIEF DESCRIPTION OF THE FIGURES

FIG. 1 shows a transaction network according to an embodiment of the present disclosure.

FIG. 2 shows a server device according to an embodiment of the present disclosure.

FIG. 3 shows a transfer process using untrained reinforcement learning according to an embodiment of the present disclosure.

FIG. 4 shows a transfer process using reinforcement learning based on observed effects according to an embodiment of the present disclosure.

### DETAILED DESCRIPTION OF SEVERAL EMBODIMENTS

An automated system may monitor user behavior when interacting with a plurality of financial accounts and identify one or more changes that can be made to the accounts to optimize one or more financial benefits associated with the accounts. In some embodiments, the automated system may learn how to fully manage a user's accounts without user intervention. The automated system may use reinforcement learning to identify the changes and optimize the benefits. Accordingly, the system may perform the automatic account monitoring and optimization without requiring training on individual users. This may allow the system to start working to optimize the benefits more quickly and store and/or maintain less data than systems that optimize accounts using other automatic and/or machine learning techniques. This may also allow the system to adapt to different user environments. For example, different users may have different account types and behaviors, and the system may use automated reinforcement learning to adapt and develop policies for any user environment, thereby maximizing benefits for each particular environment individually, without training or preconceived requirements. Moreover, the automated reinforcement learning may generate and/or refine policies of arbitrary complexity that apply to changes to multiple accounts, thereby providing the aforementioned data efficiency gains to more complex systems and policies than other automatic and/or machine learning techniques.

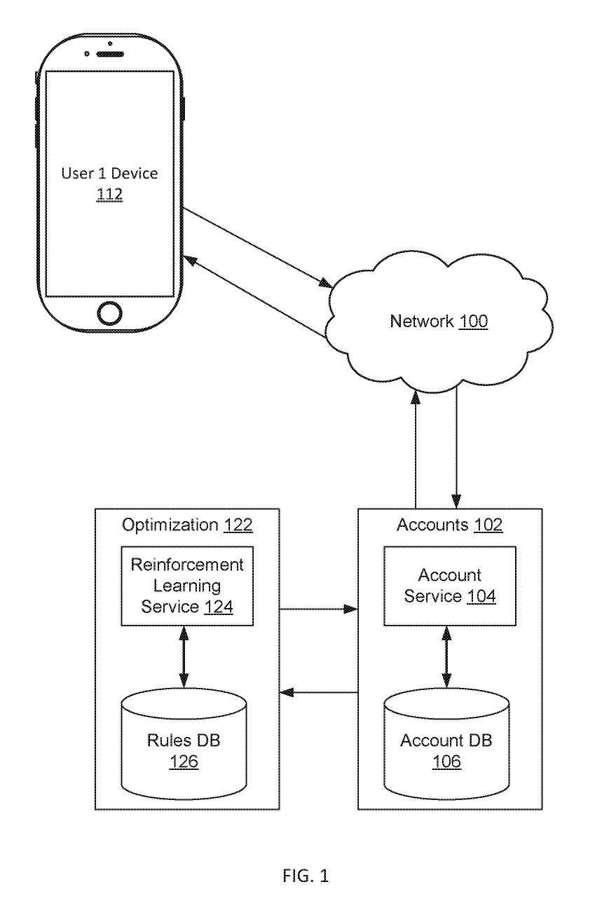

FIG. 1 shows a transaction network 100 according to an embodiment of the present disclosure. Network 100 may include the Internet, one or more local or enterprise networks, other networks, and/or a combination thereof.

One or more user devices 112 may be connected to network 100. User devices 112 may include devices such as smartphones, laptops, desktops, workstations, tablets, and/or other computing devices. While one user device 112 is shown in FIG. 1 for ease of illustration, any number of user devices 112 may connect to network 100. User devices 112 may include hardware, software, and/or firmware configured to communicate with other computing devices to effect transactions as described herein. For example, user device 112 may include an app, web browser, or other hardware, software, and/or firmware configured to communicate with account server 102 to request financial transactions, as described in greater detail below.

One or more account servers 102 may be connected to network 100. Account server 102 may be a computing device, such as a server or other computer. Account server 102 may include account service 104 configured to receive transaction requests and/or other information from user devices 112, process and/or record the transactions, and send information about accounts and/or transactions to user devices 112. Account server 102 may include account database 106. Account database 106 may include account data and/or transaction records, for example.

Account server 102 is depicted as a single server including a single account service 104 and account database 106 in FIG. 1 for ease of illustration, but those of ordinary skill in the art will appreciate that account server 102 may be embodied in different forms for different implementations. For example, account server 102 may include a plurality of servers. Account service 104 may comprise a variety of services such as an application programming interface (API) configured for handling inbound requests for transactions and/or a service configured for processing transactions and/or interacting with account database 106, for example.

One or more optimization servers 122 may be connected to account server 102. Optimization server 122 is connected to account server 102 by a private connection (e.g., not the public Internet 100) in FIG. 1, but in some embodiments, optimization server 122 may be connected to account server 102 by the same network 100 used for communications between account server 102 and user devices 112. Optimization server 122 may include reinforcement learning service 124 configured to monitor activities performed by account service 104 and send transaction commands to account service 104, as described in greater detail below. Optimization server 122 may include policy database 126. Policy database 126 may include policies defining how reinforcement learning service 124 may issue commands to account service 104 and/or results of reinforcement learning processing, for example, as described in greater detail below.

Optimization server 122 is depicted as a single server including a single reinforcement learning service 124 and policy database 126 in FIG. 1 for ease of illustration, but those of ordinary skill in the art will appreciate that optimization server 122 may be embodied in different forms for different implementations. For example, optimization server 122 may include a plurality of servers. In some embodiments, reinforcement learning service 124 and policy database 126 may be provided by the same server as account service 104 and account database 106.

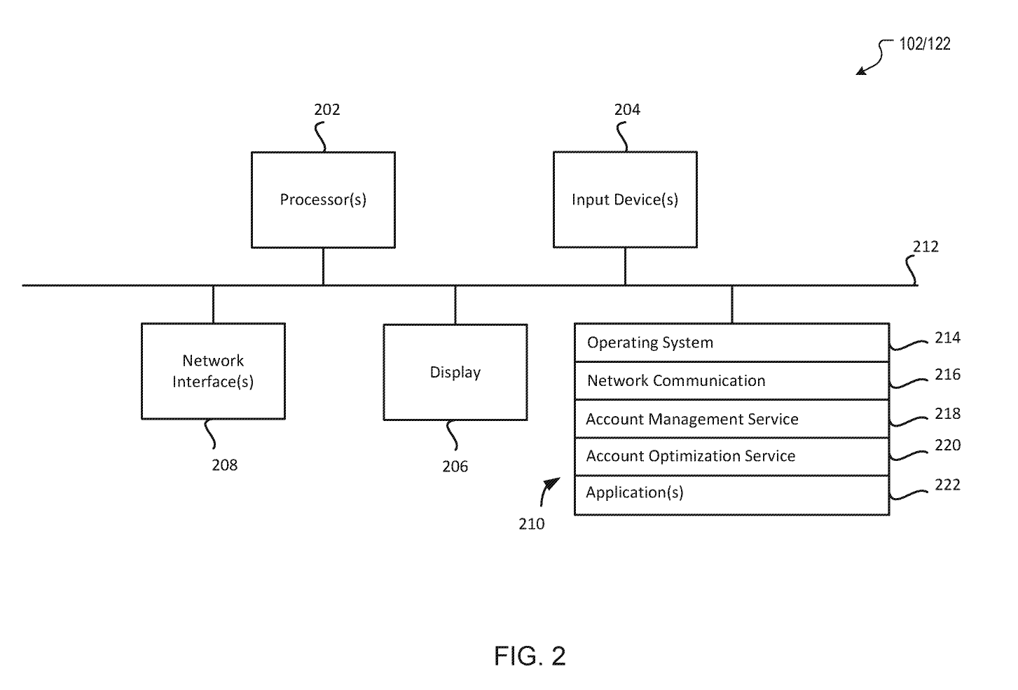

FIG. 2 is a block diagram of an example computing device that may implement various features and processes as described herein. For example, the computing device may serve as account server 102, optimization server 122, or a combination thereof. Some embodiments of the present disclosure may include multiple computing devices 102/122 (e.g., at least one account server 102 and at least one optimization server 122). The computing device 102/122 may be implemented on any electronic device that runs software applications derived from compiled instructions, including without limitation personal computers, servers, smart phones, media players, electronic tablets, game consoles, email devices, etc. In some implementations, the computing device 102/122 may include one or more processors 202, one or more input devices 204, one or more display devices 206, one or more network interfaces 208, and one or more computer-readable mediums 210. Each of these components may be coupled by bus 212.

Display device 206 may be any known display technology, including but not limited to display devices using Liquid Crystal Display (LCD) or Light Emitting Diode (LED) technology. Processor(s) 202 may use any known processor technology, including but not limited to graphics processors and multi-core processors. Input device 204 may be any known input device technology, including but not limited to a keyboard (including a virtual keyboard), mouse, track ball, and touch-sensitive pad or display. Bus 212 may be any known internal or external bus technology, including but not limited to ISA, EISA, PCI, PCI Express, NuBus, USB, Serial ATA or FireWire. Computer-readable medium 210 may be any medium that participates in providing instructions to processor(s) 202 for execution, including without limitation, non-volatile storage media (e.g., optical disks, magnetic disks, flash drives, etc.), or volatile media (e.g., SDRAM, ROM, etc.).

Computer-readable medium 210 may include various instructions 214 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 204; sending output to display device 206; keeping track of files and directories on computer-readable medium 210; controlling peripheral devices (e.g., disk drives, printers, etc.) which can be controlled directly or through an I/O controller; and managing traffic on bus 212. Network communications instructions 216 may establish and maintain network connections (e.g., software for implementing communication protocols, such as TCP/IP, HTTP, Ethernet, telephony, etc.).

Account management service instructions 218 can include instructions that cause optimization server 122 to interact with account server 102 as described herein. For example, account management service instructions 218 may monitor transactions and/or send transaction instructions. Account optimization service instructions 220 can include instructions that perform reinforcement learning using observed transactions and develop policies for account optimization as described herein. For example, account optimization service instructions 220 may process transaction data gathered using account management service instructions 218 using reinforcement learning techniques and develop policies that trigger account management service instructions 218 to issue transaction requests that may optimize account benefits.

Application(s) 220 may be an application that uses or implements the processes described herein and/or other processes. The processes may also be implemented in operating system 214.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

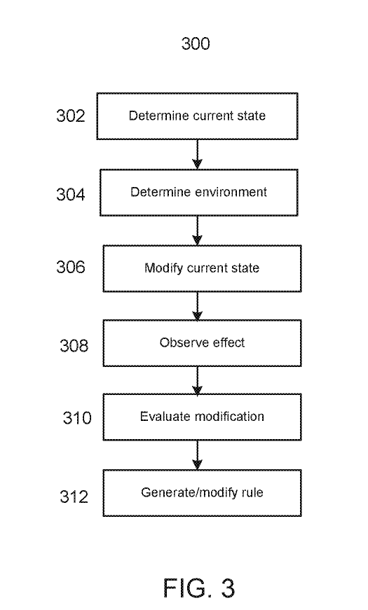

FIG. 3 shows a transfer process using untrained reinforcement learning 300 according to an embodiment of the present disclosure. An optimization server 122 including a reinforcement learning service 124 may perform process 300, for example.

At 302, optimization server 122 may determine current states of a user's accounts managed by account server 102. For example, the reinforcement learning process may use a state concept, wherein the learning and actions taken begin from an initial account state the first time process 300 occurs, or from a current state for subsequent iterations. The initial state may be a current state for the first iteration. Each account may have its own state. For example, the user may have a checking account and a savings account managed by account server 102. Each account may have an account number or other identifier, an account type (e.g., checking or savings), a current balance, a current interest rate, and one or more policies governing transactions that are possible for the account. These account characteristics may define the account's state.

At 304, optimization server 122 may determine an environment describing all of the user's accounts. The environment may include each account state and additional factors affecting what can be done with the accounts. For example, additional factors may include laws and/or regulations governing transactions that are possible. Additional factors may include data describing consequences and/or results of transactions (e.g., if $100 is moved from savings to checking, the results may include a new state for the savings account, a new state for the checking account, and possibly a new limit on transactions (e.g., if withdrawals are limited to a certain number per time period, one less withdrawal is available)). The environmental determination may be unique to the specific user's accounts, allowing the optimizations to be customized to the user's accounts through reinforcement learning.

At 306, optimization server 122 may modify a current state. For example, optimization server 122 may direct account server 102 to transfer money from one account to another, thereby effecting a change in the current states of the accounts. For example, optimization server 122 may direct account server 102 to transfer $50 from checking to savings.

At 308, optimization server 122 may observe the effect of the modification. In the example wherein optimization server 122 directed account server 102 to transfer $50 from checking to savings, optimization server 122 may determine whether this transfer resulted in a change to the user's financial situation. For example, the transfer may have put more money into an account with higher interest, so it may have resulted in stronger interest earnings for an interest period. However, the transfer may have caused insufficient funds to be present in the checking account for a user to make a bill payment, resulting in overdraft fees or requiring the user to log into their accounts to move money back from savings to checking.

At 310, optimization server 122 may evaluate the effects of the modification. Continuing the example above, in some cases transferring money from checking to savings may have a positive outcome because of improved interest earnings. However, in other cases, transferring money from checking to savings may have a negative outcome because of overdrafts incurred or retransfer requirements in order to pay a bill. Optimization server 122 may apply one or more reinforcement learning algorithms to evaluate the outcome. For example, any known reinforcement learning techniques may be used. The modification may be made, and its effects evaluated, without prior training or manual establishment of policies.

At 312, optimization server 122 may generate a policy based on the evaluating. For example, the one or more reinforcement learning algorithms may reinforce changes that produce good outcomes and/or move away from changes that produce bad outcomes. Thus, if the transfer results in increased interest earnings without negative consequences, optimization server 122 may store a policy in policy database 126 causing the same transfer to be repeated periodically. On the other hand, if the transfer results in a lack of funds for a repetitive transaction (e.g., a monthly bill payment), optimization server 122 may store a policy in policy database 126 that does not repeat the same transfer, and may instead prescribe a different transfer amount, timing, and/or direction. In some embodiments, the reinforcement learning algorithms may favor particular types of benefits (e.g., based on account type or user preference input to optimization server 122). For example, a user may strongly prefer maximizing interest gains, so policies that accomplish this goal may be favored. The policy may be customized to the specific user environment based on the specific reinforcement learning performed in the environment and without prior training or manual establishment of policies.

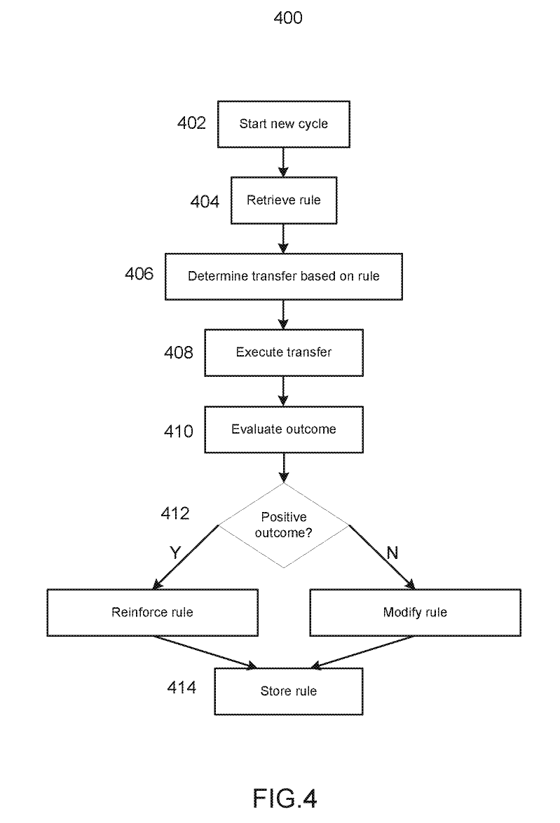

FIG. 4 shows a transfer process using reinforcement learning 400 based on observed effects according to an embodiment of the present disclosure. An optimization server 122 including a reinforcement learning service 124 may perform process 400, for example.

At 402, optimization server 122 may begin a new cycle of state evaluation, modification, and learning. For example, process 300 may be performed a first time a user's accounts are processed by optimization server 122. After policies are established by process 300, process 400 may further refine the policies in subsequent cycles.

At 404, optimization server 122 may retrieve one or more policies from policy database 126 that apply to a user's accounts. For example, the policies may have been created by optimization server performing process 300 and/or by performing previous iterations of process 400. However, as noted above, these polices need not be supplied through training or administrative action. Instead, the policies may be generated specifically for the user's account environment based on reinforcement learning.

At 406, optimization server 122 may determine a state modification based on the retrieved policy. Continuing the example of process 300 above, optimization server 122 may determine that account server 102 should transfer $50 from checking to savings if that change previously resulted in a positive outcome. If not, optimization server 122 may determine that account server 102 should perform a different transfer, such as a transfer of $25 from checking to savings.

At 408, optimization server 122 may modify a current state. For example, optimization server 122 may direct account server 102 to transfer money from one account to another based on the determined state modification from 406, thereby effecting a change in the current states of the accounts. In some embodiments, optimization server 122 may be configured to optionally or occasionally modify the current state contrary to the retrieved policy. In effect, optimization server 122 may perform an experiment using a different modification and observe the effects thereof. For example, the policy may say account server 102 should transfer $50 from checking to savings, but optimization server 122 may direct account server 102 to transfer $100 from checking to savings.

At 410, optimization server 122 may evaluate the effects of the modification. For example, as noted above, in some cases transferring money from checking to savings may have a positive outcome because of improved interest earnings. However, in other cases, transferring money from checking to savings may have a negative outcome because of overdrafts incurred or retransfer requirements in order to pay a bill. Optimization server 122 may apply one or more reinforcement learning algorithms to evaluate the outcome. For example, any known reinforcement learning techniques may be used.

At 412, optimization server 122 may modify, or choose not to modify, the applied policy based on the evaluating. For example, the one or more reinforcement learning algorithms may reinforce changes that produce good outcomes and/or move away from changes that produce bad outcomes. Thus, if the transfer results in increased interest earnings without negative consequences, optimization server 122 may determine that the policy should be maintained. On the other hand, if the transfer results in a lack of funds for a repetitive transaction (e.g., a monthly bill payment), optimization server 122 may determine a change to the policy that may cause a different transfer amount, timing, and/or direction. In cases where experiments were performed (e.g., the transfer of $100 despite the policy to transfer $50), the policy may be modified when the outcome of the experimental modification was positive. The modification at 412 may be considered a reward metric used to determine whether the policy being adjusted/discovered is correct. The algorithm(s) may be configured to maximize a positive reward or minimize a negative reward. The reward might also be an accumulation over a period of time. One implementation might have the reward be incremented when something positive happens and decremented when something negative happens. Another implementation might use a projected cash balance, or end of period balance net of fees/penalties as the reward.

At 414, optimization server 122 may either maintain the policy in policy database 126 if applying the policy had positive consequences, or may store the changed policy in policy database 126 if applying the policy had negative consequences. By reinforcing or modifying policies iteratively using a reinforcement learning technique as described above, optimization server 122 may, over time, develop policies for the accounts that optimize or nearly optimize financial benefits to the user. Accordingly, repeated performance of process 400 may allow optimization server 122 to automatically manage the user's accounts during times between external deposits and withdrawals.

Optimization server 122 may perform process 400 periodically (e.g., once a day). Note that because policies are either maintained or replaced with modified policies, policy database 126 may only need to store one policy or small set of policies for each user. Policy database 126 may not need to keep a record of policy performance in the past. Accordingly, process 400 may reduce the amount of data required to automatically manage accounts by using the above-described reinforcement learning techniques. Optimization server 122 may not need to generate a training data set to begin optimizing accounts and, through process 300, can begin working to optimize accounts without having background information about the accounts in advance (e.g., without knowing user deposit/withdrawal patterns, etc.).

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown. For example, while many illustrations provided herein deal with use cases for a user having two depository accounts, those of ordinary skill will appreciate that the same systems and methods may apply to scenarios involving more than two accounts and/or involving different kinds of accounts (e.g., credit accounts, investment accounts, etc.).

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. An automatic account management method comprising:
receiving, at a processor, first account state data for a first network-accessible account associated with an account holder, the first account data including a first value held in the first network-accessible account;
receiving, at the processor, second account state data for a second network-accessible account associated with the account holder, the second account data including a second value held in the second network-accessible account;
automatically executing, by the processor, a first transfer of value between the first network-accessible account and the second network-accessible account, the executing including issuing a command to at least one of the first network-accessible account and the second network-accessible account through a network interface, the transfer causing a change in the first value and a change in the second value, the transfer including at least one transfer characteristic defined by a transfer policy established by a reinforcement learning algorithm and stored in at least one memory, the at least one transfer characteristic defining at least one of:
a first frequency at which the processor automatically executes the transfer of value,
a first timing at which the processor automatically executes the transfer of value, and
the value of the first transfer;
storing, by the processor, data describing the change in the first value in a first account data record in the at least one memory;
storing, by the processor, data describing the change in the second value in a second account data record in the at least one memory;
detecting, by the processor, a user-initiated transfer of value involving at least one of the first network-accessible account and the second network-accessible account;
automatically applying, by the processor, the reinforcement learning algorithm to determine an effect of the automatically-executed first transfer of value, wherein the reinforcement learning algorithm determines the effect by evaluating states of the first network-accessible account and the second network-accessible account before and after the automatically executed first transfer of value and the user-initiated transfer of value;
automatically modifying, by the processor, the transfer policy in the at least one memory to change the at least one transfer characteristic according to the effect of the automatically-executed first transfer of value, the change in the at least one transfer characteristic being configured to increase an overall account value; and
automatically executing, by the processor, a second transfer of value between the first network-accessible account and the second network-accessible account according to the modified transfer policy, the executing including issuing a second command to at least one of the first network-accessible account and the second network-accessible account through the network interface according to the modified transfer policy, the transfer causing a further change in the first value and a further change in the second value.

2. The method of claim 1, wherein:
the effect includes an increase in overall account value; and
modifying the transfer policy includes indicating that the automatically-executed first transfer of value is to be repeated.

3. The method of claim 1, wherein:
the effect includes a decrease in overall account value; and
modifying the transfer policy includes indicating that the automatically-executed first transfer of value is to be changed.

4. The method of claim 3, wherein indicating that the automatically-executed first transfer of value is to be changed includes at least one of changing a timing for the automatically-executed first transfer of value, changing a value of the automatically-executed first transfer of value, and changing a direction of the automatically-executed first transfer of value.

5. The method of claim 1, wherein:
the first account state data indicates at least one action that can be performed to change the first value;
the second account state data indicates at least one action that can be performed to change the second value; and
the method further comprises identifying, by the processor, the transfer policy based on at least one of the first account state data and the second account state data.

6. The method of claim 1, further comprising:
receiving, at the processor, environmental data indicating how the first transfer of value is allowed to be executed; and
identifying, by the processor, the transfer policy based on the environmental data.

7. The method of claim 1, further comprising identifying, by the processor, the transfer policy based on a previously-observed outcome, an experimental choice, or a combination thereof.

8. An automatic account management policy creation method comprising:
receiving, at a processor, first account state data for a first network-accessible account associated with an account holder, the first account data including a first value held in the first network-accessible account;
receiving, at the processor, second account state data for a second network-accessible account associated with the account holder, the second account data including a second value held in the second network-accessible account;
automatically determining, by the processor, a first transfer of value for execution between the first network-accessible account and the second network-accessible account, the executing including issuing a command to at least one of the first network-accessible account and the second network-accessible account through a network interface, the transfer including at least one transfer characteristic and causing a change in the first value and a change in the second value, the at least one transfer characteristic defining at least one of:
a first frequency at which the processor automatically executes the transfer of value,
a first timing at which the processor automatically executes the transfer of value, and
the value of the first transfer;
automatically executing, by the processor, the transfer of value between the first network-accessible account and the second network-accessible account;
storing, by the processor, data describing the change in the first value in a first account data record in at least one memory;
storing, by the processor, data describing the change in the second value in a second account data record in at least one memory;
detecting, by the processor, a user-initiated transfer of value involving at least one of the first network-accessible account and the second network-accessible account;
automatically applying, by the processor, a reinforcement learning algorithm to determine an effect of the automatically-executed first transfer of value, wherein the reinforcement learning algorithm determines the effect by evaluating states of the first network-accessible account and the second network-accessible account before and after the automatically executed first transfer of value and the user-initiated transfer of value;
automatically generating, by the processor, a transfer policy to change the at least one transfer characteristic according to the effect of the automatically-executed first transfer of value, the change in the at least one transfer characteristic being configured to increase an overall account value;
storing, by the processor, the transfer policy in the at least one memory; and
automatically executing, by the processor, a second transfer of value between the first network-accessible account and the second network-accessible account according to the modified transfer policy, the executing including issuing a second command to at least one of the first network-accessible account and the second network-accessible account through the network interface according to the transfer policy, the transfer causing a further change in the first value and a further change in the second value.

9. The method of claim 8, wherein:
the effect includes an increase in overall account value; and
generating the transfer policy includes indicating that the automatically-executed first transfer of value is to be repeated.

10. The method of claim 8, wherein:
the effect includes a decrease in overall account value; and
generating the transfer policy includes specifying a different automatically-executed second transfer of value from the automatically-executed first transfer of value that produced the negative outcome.

11. The method of claim 10, wherein the different automatically-executed second transfer of value differs from the automatically-executed first transfer of value that produced the negative outcome in at least one of a timing for the automatically-executed second transfer of value, a value of the automatically-executed second transfer of value, and a direction of the automatically-executed second transfer of value.

12. The method of claim 8, wherein:
the first account state data indicates at least one action that can be performed to change the first value;
the second account state data indicates at least one action that can be performed to change the second value; and
automatically determining the first transfer of value is based on at least one of the first account state data and the second account state data.

13. The method of claim 8, further comprising:
receiving, at the processor, environmental data indicating how the transfer of value is allowed to be executed;
wherein automatically determining the first transfer of value is based on the environmental data.

14. An automatic account management system comprising:
at least one account server configured to:
store first account state data for a first network-accessible account associated with an account holder, the first account data including a first value held in the first network-accessible account;
store second account state data for a second network-accessible account associated with the account holder, the second account data including a second network-accessible value held in the second account; and
execute transfers of value causing changes in the first value and/or the second value; and
at least one account optimization apparatus comprising:
a processor; and
a non-transitory computer readable memory configured to store a transfer policy and instructions that, when executed by the processor, cause the processor to perform processing comprising:
automatically issuing a command to the at least one account server directing the at least one account server to execute a first transfer of value between the first network-accessible account and the second network-accessible account, the first transfer including at least one transfer characteristic defined by the transfer policy and causing a change in the first value and a change in the second value, wherein the at least one account server stores data describing the change in the first value and data describing the change in the second value, the at least one transfer characteristic defining at least one of:
a first frequency at which the processor automatically executes the transfer of value,
a first timing at which the processor automatically executes the transfer of value, and
the value of the first transfer;
detecting a user-initiated transfer of value involving at least one of the first network-accessible account and the second network-accessible account;
automatically applying, by the processor, a reinforcement learning algorithm to determine an effect of the automatically-executed first transfer of value, wherein the reinforcement learning algorithm determines the effect by evaluating states of the first network-accessible account and the second network-accessible account before and after the automatically executed first transfer of value and the user-initiated transfer of value;
automatically storing or modifying the transfer policy in the memory to change the at least one transfer characteristic according to the effect of the automatically-executed first transfer of value, the change in the at least one transfer characteristic being configured to increase an overall account value; and
automatically issuing a second command to the at least one account server directing the at least one account server to execute a second transfer of value between the first network-accessible account and the second network-accessible account according to the stored or modified transfer policy, the transfer causing a further change in the first value and a further change in the second value.

15. The system of claim 14, wherein:
the effect includes an increase in overall account value; and
storing or modifying the transfer policy includes indicating that the automatically-executed first transfer of value is to be repeated.

16. The system of claim 14, wherein:
the effect includes a decrease in overall account value;
storing the transfer policy includes specifying a different automatically-executed second transfer of value from the automatically-executed first transfer of value that produced the negative outcome; and
modifying the transfer policy includes indicating that the automatically-executed first transfer of value is to be changed.

17. The system of claim 16, wherein indicating that the automatically-executed first transfer of value is to be changed includes at least one of changing a timing for the automatically-executed second transfer of value, changing a value of the automatically-executed second transfer of value, and changing a direction of the automatically-executed second transfer of value.

18. The system of claim 14, wherein:
the first account state data indicates at least one action that can be performed to change the first value;
the second account state data indicates at least one action that can be performed to change the second value; and
the transfer policy is based on at least one of the first account state data and the second account state data.

19. The system of claim 14, wherein the processing further comprises:
receiving environmental data indicating how the first transfer of value is allowed to be executed; and
identifying a transfer policy specifying the first transfer of value based on the environmental data.

20. The system of claim 14, wherein the processing further comprises identifying a transfer policy specifying the first transfer of value based on a previously-observed outcome, an experimental choice, or a combination thereof.
